(19) United States
(12) Patent Application Publication
(10) Pub. No.: US 2024/0425764 A1
(43) Pub. Date: Dec. 26, 2024

(54) SYSTEMS AND PROCESSES FOR LIPID FEEDSTOCK TREATMENT WITH MOVING BED REACTOR

(71) Applicant: CHEVRON U.S.A. INC., San Ramon, CA (US)

(72) Inventors: Sven Ivar Hommeltoft, Pleasant Hill, CA (US); Steven Xuqi Song, El Cerrito, CA (US)

(21) Appl. No.: 18/748,732

(22) Filed: Jun. 20, 2024

Related U.S. Application Data
(60) Provisional application No. 63/521,947, filed on Jun. 20, 2023.

(51) Int. Cl. C10G 3/00; B01J 8/00; B01J 8/18; B01J 8/26; B01J 21/04; B01J 23/02; B01J 23/92; B01J 38/02; C10L 1/06; C10L 1/08

(52) U.S. Cl. CPC C10G 3/48; B01J 8/0055; B01J 8/1827; B01J 8/1881; B01J 8/26; B01J 21/04; B01J 23/02; B01J 23/92; B01J 38/02; C10G 3/50; C10L 1/06; C10L 1/08; B01J 2208/00769; C10G 2400/02; C10G 2400/04; C10L 2270/04

(57) ABSTRACT

A lipid feedstock including fatty acid(s) is treated in a process flow through a moving bed reactor with catalyst to produce a treated stream. The catalyst may include metal oxide catalyst on a particulate oxide support. The catalyst may be transferred, using a catalyst withdrawal line, from the bottom of the moving bed reactor to a fluidized bed regenerator, and regenerated. The catalyst may be transferred from the fluidized bed regenerator to a cyclone that separates the catalyst from flue gas. The catalyst may be transferred from the cyclone to the top of the moving bed reactor using a catalyst feed line. A first separation gas may be flowed into the catalyst feedline, and a second separation gas may be flowed into the bottom of the moving bed reactor or into the catalyst withdrawal line, to generate pressure differentials driving the process flow through the moving bed reactor.

### CROSS-REFERENCE TO RELATED APPLICATIONS

This application claims the benefit of U.S. Provisional Patent Application No. 63/521,947, filed Jun. 20, 2023 and entitled “Process for Lipid Feedstock Treatment with Moving Bed Reactor,” the entire contents of which are incorporated by reference herein.

### FIELD

This application relates to systems and processes for lipid feedstock treatment.

### BACKGROUND

There is an increasing interest in alternative feedstocks for replacing at least partly crude oil, in the production of hydrocarbons, suitable as fuels or fuel components, for example as transportation fuels, or compatible with fuels. Biofuels are typically manufactured from feedstock originating from renewable sources including oils and fats obtained from plants, animals, algal materials, fish, and various waste streams, side streams and sewage sludge.

Despite the ongoing research and development in the processing of renewable feedstocks and manufacture of fuels, there is still a need to provide an improved process for purifying renewable feedstock to provide purified feedstock, which is suitable for converting to valuable chemicals, such as hydrocarbons suitable as fuels or fuel blending components. In particular, there is a need for reactor systems that can efficiently process such alternative and renewable feedstocks, particularly lipid containing feedstocks.

### SUMMARY

Some examples herein provide ketopyrolysis of a lipid feedstock using a moving bed reactor with a counter current process.

Some examples herein provide ketopyrolysis of a lipid feedstock using a moving bed reactor with counter flow, up-flow regeneration.

Some examples herein provide ketopyrolysis of a lipid feedstock using a cross flow/radial converter moving bed.

Some examples herein provide a process for converting a lipid feedstock to a fuel that includes ketopyrolysis of a lipid containing feedstock using a moving bed reactor system that achieves an operable valve-free moving bed reactor loop and eliminates/avoids pressure loop problems associated with the reactor and regenerator both flowing in the same direction around the loop as the catalyst.

Some examples herein provide a process for converting a lipid feedstock to a fuel that includes ketopyrolysis of a lipid containing feedstock using a moving bed reactor system that achieves an operable valve-free moving bed reactor loop by reversing the process flow direction in the reactor to up-flow so that the catalyst flows in the opposite direction of the process flow in the reactor.

Some examples herein provide a process for converting a lipid feedstock to a fuel that includes ketopyrolysis of a lipid containing feedstock using a moving bed reactor system that achieves an operable valve-free moving bed reactor loop by reversing the process flow direction in the regenerator to flow in opposite direction of the gravity driven catalyst flow.

Some examples herein provide a process for converting a lipid feedstock to a fuel that includes ketopyrolysis of a lipid containing feedstock using a moving bed reactor system that avoids pressure drop in the direction of the catalyst flow by flowing the process stream in cross flow in a radial converter reactor configuration.

Some examples herein provide a process. The process may include treating a lipid feedstock in a process flow through a moving bed reactor with a particulate catalyst under treating conditions to produce a treated stream. The moving bed reactor may include a top and a bottom, the lipid feedstock may include at least one fatty acid, and the particulate catalyst may include a metal oxide catalyst on an oxide support. The process may include transferring the particulate catalyst from the bottom of the moving bed reactor to a fluidized bed regenerator using a catalyst withdrawal line. The process may include regenerating the particulate catalyst using the fluidized bed regenerator. The process may include transferring the particulate catalyst from the fluidized bed regenerator to a cyclone. The process may include separating the particulate catalyst from flue gas using the cyclone. The process may include transferring the particulate catalyst from the cyclone to the top of the moving bed reactor using a catalyst feed line having an inlet. The process may include flowing a first separation gas into the inlet of the catalyst feedline to generate a first pressure differential driving the process flow through the moving bed reactor. The process may include flowing a second separation gas into an inlet at the bottom of the moving bed reactor or into an inlet of the catalyst withdrawal line to generate a second pressure differential further driving the process flow through the moving bed reactor.

In some examples, the cyclone is operationally located between the fluidized bed regenerator and the moving bed reactor.

In some examples, the particulate catalyst flows in a same direction as the process flow. In some examples, the particulate catalyst flows in an opposite direction as the process flow.

In some examples, the method includes flowing the second separation gas into both the bottom of the moving bed reactor and into the inlet of the catalyst withdrawal line to further drive the process flow through the moving bed reactor.

In some examples, the process flow does not pass through a valve.

In some examples, the first separation gas includes steam or an inert gas. In some examples, the second separation gas includes steam or an inert gas.

In some examples, the particulate catalyst is transferred from the fluidized bed regenerator to the cyclone using a riser having a first end coupled to the fluidized bed regenerator and a second end coupled to the cyclone.

In some examples, the lipid feedstock is input at the top of the fluidized bed regenerator. In some examples, the lipid feedstock is input between the top and the bottom of the fluidized bed regenerator.

In some examples, the moving bed reactor includes a radial converter, and wherein the process flow includes flow of the product stream from a central axis of the radial converter to a periphery of the radial converter.

In some examples, the particulate catalyst is in a cross-flow to the flow of the product stream.

In some examples, the fluidized bed regenerator is operationally located between the cyclone and the moving bed reactor.

In some examples, the particulate catalyst flows in a same direction as the process flow within the moving bed reactor. In some examples, the particulate catalyst flows in an opposite direction as the process flow within the fluidized bed regenerator.

In some examples, the catalyst withdrawal line has a first end coupled to the bottom of the moving bed reactor, and a second end, and wherein the particulate catalyst is transferred from the moving bed reactor to the cyclone using (i) the catalyst withdrawal line; and (ii) a riser having a first end coupled to the second end of the catalyst withdrawal line, and a second end coupled to the cyclone.

In some examples, the method further includes withdrawing the treated stream from the bottom of the moving bed reactor. In some examples, the method further includes withdrawing the treated stream from the top of the moving bed reactor.

In some examples, the method further includes performing one or more hydroprocessing steps. In some examples, the one or more hydroprocessing steps are selected from the group consisting of: hydrogenation, double bond saturation, hydrodeoxygenation, hydrocracking, hydro-isomerization, hydrodesulfurization, hydrodenitrogenation, hydrodearomatization, hydrodewaxing, and mild hydrocracking.

In some examples, the metal oxide catalyst includes at least one metal selected from the group consisting of Na, K, Mg, Ca, and Sr. In some examples, the metal oxide catalyst includes at least one metal selected from the group consisting of Na, K, Ca, and Mg. In some examples, the metal oxide catalyst includes calcium oxide. In some examples, the oxide support includes alumina. In some examples, the metal oxide catalyst on the oxide support includes particles with sizes in the range of about 0.05 mm to about 0.2 mm.

In some examples, the treated stream includes a renewable fuel intermediate composition. In some examples, the renewable fuel intermediate composition includes less than about 70 wt % of an amount of oxygen in the high-phosphorous lipid feedstock. In some examples, the renewable fuel intermediate composition includes a mixture of organic compounds primarily having a boiling point above about 150° C. In some examples, the method further includes hydroprocessing a fraction of the renewable fuel intermediate composition to aviation fuel, diesel, naphtha, or gasoline.

In some examples, the treating conditions in the moving bed reactor include a temperature in a range of from 400° C. to 700° C., a pressure in a range from 0 to 10 mPa, and a liquid hourly space velocity in a range from 0.1 to 10 h⁻¹.

Some examples herein provide a system. The system may include a moving bed reactor to treat a lipid feedstock in a process flow through the moving bed reactor with a particulate catalyst under treating conditions to produce a treated stream. The moving bed reactor may include a top and a bottom, the lipid feedstock may include at least one fatty acid, and the particulate catalyst may include a metal oxide catalyst on an oxide support. The system may include a fluidized bed regenerator to regenerate the particulate catalyst. The system may include a catalyst withdrawal line to transfer the particulate catalyst from the bottom of the moving bed reactor to the fluidized bed regenerator. The system may include a cyclone to separate the particulate catalyst from flue gas. The system may include a riser to transfer the particulate catalyst to the cyclone. The system may include a catalyst feed line to transfer the particulate catalyst from the cyclone to the top of the moving bed reactor. The catalyst feed line may have an inlet to flow a first separation gas into the catalyst feedline to generate a first pressure differential driving the process flow through the moving bed reactor. The bottom of the moving bed reactor may have an inlet or the catalyst withdrawal line may have an inlet to flow a second separation gas into the bottom of the moving bed reactor or into the catalyst withdrawal line to generate a second pressure differential further driving the process flow through the moving bed reactor.

In some examples, the cyclone is operationally located between the fluidized bed regenerator and the moving bed reactor.

In some examples, the particulate catalyst flows in a same direction as the process flow. In some examples, the particulate catalyst flows in an opposite direction as the process flow.

In some examples, the second separation gas flows into both the bottom of the moving bed reactor and into the inlet of the catalyst withdrawal line to further drive the process flow through the moving bed reactor.

In some examples, the process flow does not pass through a valve.

In some examples, the first separation gas includes steam or an inert gas. In some examples, the second separation gas includes steam or an inert gas.

In some examples, the riser has a first end coupled to the fluidized bed regenerator and a second end coupled to the cyclone.

In some examples, the lipid feedstock is input at the top of the fluidized bed regenerator. In some examples, the lipid feedstock is input between the top and the bottom of the fluidized bed regenerator.

In some examples, the moving bed reactor includes a radial converter, and the process flow includes flow of the product stream from a central axis of the radial converter to a periphery of the radial converter.

In some examples, the particulate catalyst is in a cross-flow to the flow of the product stream.

In some examples, the fluidized bed regenerator is operationally located between the cyclone and the moving bed reactor.

In some examples, the particulate catalyst flows in a same direction as the process flow within the moving bed reactor. In some examples, the particulate catalyst flows in an opposite direction as the process flow within the fluidized bed regenerator.

In some examples, the catalyst withdrawal line has a first end coupled to the bottom of the moving bed reactor, and a second end, the riser has a first end coupled to the second end of the catalyst withdrawal line, and a second end coupled to the cyclone, and the particulate catalyst is transferred from the moving bed reactor to the cyclone using the catalyst withdrawal line.

In some examples, the treated stream is withdrawn from the bottom of the moving bed reactor. In some examples, the treated stream is withdrawn from the top of the moving bed reactor.

In some examples, the system further includes a hydroprocessor to perform one or more hydroprocessing steps. In some examples, the one or more hydroprocessing steps are selected from the group consisting of: hydrogenation, double bond saturation, hydrodeoxygenation, hydrocracking, hydro-isomerization, hydrodesulfurization, hydrodenitrogenation, hydrodearomatization, hydrodewaxing, and mild hydrocracking.

In some examples, the metal oxide catalyst includes at least one metal selected from the group consisting of Na, K, Mg, Ca, and Sr. In some examples, the metal oxide catalyst includes at least one metal selected from the group consisting of Na, K, Ca, and Mg. In some examples, the metal oxide catalyst includes calcium oxide. In some examples, the oxide support includes alumina. In some examples, the metal oxide catalyst on the oxide support includes particles with sizes in the range of about 0.05 mm to about 0.2 mm.

In some examples, the treated stream includes a renewable fuel intermediate composition. In some examples, the renewable fuel intermediate composition includes less than about 70 wt % of an amount of oxygen in the high-phosphorous lipid feedstock. In some examples, the renewable fuel intermediate composition includes a mixture of organic compounds primarily having a boiling point above about 150° C.

In some examples, the system further includes a hydroprocessor to hydroprocess a fraction of the renewable fuel intermediate composition to aviation fuel, diesel, naphtha, or gasoline.

In some examples, the treating conditions in the moving bed reactor include a temperature in a range of from 400° C. to 700° C., a pressure in a range from 0 to 10 mPa, and a liquid hourly space velocity in a range from 0.1 to 10 h⁻¹.

Some examples herein provide a process. The process may include treating a lipid feedstock including at least one fatty acid in a moving bed reactor with a metal oxide catalyst on an oxide support under treating conditions to produce a treated stream. The moving bed reactor may include an operable valve-free moving bed reactor loop. The treating conditions in the moving bed reactor may include a temperature in a range of from 400° C. to 700° C., a pressure in a range from 0 to 10 mPa, and a liquid hourly space velocity in a range from 0.1 to 10 h⁻¹.

In some examples, the moving bed reactor loop includes reversing the process flow direction in the reactor to up-flow.

In some examples, a regenerator is present and the reactor and regenerator both flow in the same direction around the loop as the catalyst. Optionally, the moving bed reactor loop includes reversing the process flow direction in the regenerator to flowing in the opposite direction of the catalyst.

In some examples, the moving bed reactor loop includes flowing the process stream in cross flow in a radial converter reactor configuration.

### BRIEF DESCRIPTION OF THE DRAWINGS

FIG. 1 schematically illustrates an example reactor system that includes a catalyst flow within a moving bed reactor loop.

FIG. 2 schematically illustrates an example moving bed reactor system that is a variation of FIG. 1 containing an “L” valve, showing desired catalyst and process flow or “fluid medium” directions and select pressures in the catalyst loop.

FIG. 3 schematically illustrates an example moving bed reactor system with up-flow process stream.

FIG. 4 schematically illustrates an example reactor system that includes an optional stream of super-heated steam or quench stream.

FIG. 5 schematically illustrates an example moving bed reactor system with moving or fluid bed counter flow regeneration with gravity driven moving bed catalyst flow in both regenerator and reactor.

FIGS. 6A-6B schematically illustrate an example process for lipid conversion in a moving bed radial converter with process stream flowing outwards from the axis of the reactor towards the periphery.

FIG. 7 illustrates an example flow of operations in a process for converting a lipid feedstock to a renewable fuel intermediate composition using a moving bed reactor.

### DETAILED DESCRIPTION

Various examples of the present invention now will be described more fully hereinafter through reference to various embodiments, and particularly in regard to the attached figures. These embodiments are provided so that this disclosure will be thorough and complete, and will fully convey the scope of the invention to those skilled in the art. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

As recognized by the present inventors, conversion of lipids to fuels within traditional refinery processes such as hydrotreating (which also may be referred to as hydroprocessing) comprises several issues.

For example, lipids like feedstocks of biological origin are rich in oxygen. This means that in traditional hydrotreating, the lipids consume a lot of hydrogen and produce so much heat that the practical capacity of a hydrotreater switching to lipids drops dramatically—by as much as 60-70%.

As another example, the lower cost lipid feedstocks, such as white grease and used cooking oil for instance, contain impurities that challenge traditional refinery processing. These impurities may include basic metals (alkaline and alkaline earth metal salts) that can foul hydrotreating catalysts' surfaces and destroy acid functionalities of hydrocrackers and fluidized catalytic cracking (FCC) catalysts. These impurities also, or alternatively, may include phosphates that simply deposit on the catalysts, inhibiting catalyst activity. These impurities also, or alternatively, may include chlorides that in hydroprocessing forms HCl, which is highly corrosive, in particular in the presence of water formed by hydrotreating oxygenates. This corrosivity is of particular concern where water starts to condense in the overhead of the product work-up.

As yet another example, most lipids predominantly consist of C16-C18 fatty acids glycerides, which by simple hydrotreating form linear C16-C18 alkanes. The cold-flow properties of these linear alkanes need to be improved through hydro-isomerization but more importantly, for jet fuel the C16-C18 range is not ideal. Jet fuel preferably is a lighter, more diverse hydrocarbon mixture covering the C8-C16 range.

In some regards, previously known techniques for ketopyrolysis can address some or all of the aforementioned challenges in a single step process. Nonlimiting examples of ketopyrolysis are described in U.S. Patent Publication No. 2022/0041938 and U.S. patent application Ser. No. 18/149,087, the entire contents of each of which are incorporated by reference herein. However, the present inventors have recognized that previously known techniques for ketopyrolysis may be undesirable under certain circumstances. For example, removal of the impurities in the low cost, low carbon intensity (CI) feedstocks forms coke on the catalyst, and the catalyst has to be regenerated in a coke burn. In addition, in some circumstances the metals and phosphorous impurities are ejected in the catalyst bed and while they-unlike in traditional hydro processing-do not influence the ketopyrolysis catalyst activity, they can make the catalyst bed “cake” together.

Moving Bed Reactors (MBRs) have been used within chemical and petrochemical industries, for example in a manner such as described by Shirzad et al., “Moving Bed Reactors: Challenges and Progress of Experimental and Theoretical Studies in a Century of Research,” Ind. Eng. Chem. Res. 58 (22): 9179-9198 (2019), the entire contents of which are incorporated by reference herein. An MBR is a catalytic reactor in which a layer of catalyst in the form of granules is moved through a reaction bed and regenerated in a regeneration unit (regenerator), continuously. Utilization of MBR within a looped system, however, may requires that the catalyst circulation and process flows move in the desired reaction. This can be most easily done using lock-hopper type arrangements with valves to control the flows in the loop and allow moving catalyst from a low pressure environment (regeneration) to a high pressure environment (reaction) while blocking process flow from flowing against the catalyst and out of the reactor. However, controlling solid particulate flows with valves exposes these valves to an abrasive service that increases the probability of failure and thereby challenges reliability of the process.

As recognized by the present inventors, a valve-free catalyst loop flow within an MBR is technically feasible but has certain limitations. Particularly, that inlet pressure as a starting point within a process stream that flows down through the reactor typically will result in a pressure drop over the reactor causing the pressure at the outlet of the reactor to be lower than the pressure at the inlet of the reactor. In small laboratory reactors or in larger reactors at very low flows, the pressure difference between inlet and outlet may not be much but for operation at industrial the pressure drop over the reactor can easily be tens of psi.

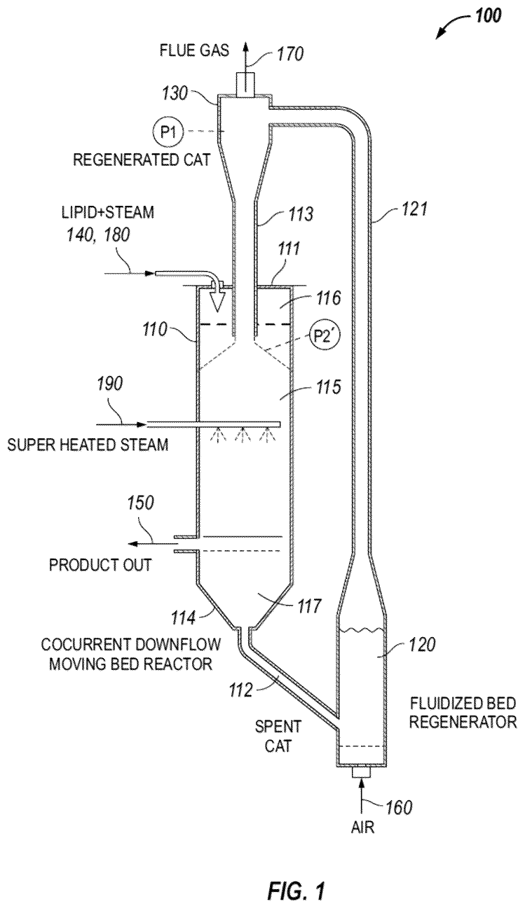

For example, in systems such as described in greater detail below with reference to FIG. 1, there will typically be a pressure drop between where the catalyst enters the reactor (P2′) and where the regenerated catalyst is separated from the regenerator flue gas (P1). It follows that under commercial scale and flow conditions, P2′<P1 and this pressure difference will typically be on the order of tens of psi. Without something blocking or sufficiently reducing the pressure difference, process feed introduced at the top of the reactor would therefore flow up through the catalyst inlet pipe and out into the flue gas vent. If valves are to be avoided (for example, because of their relatively low durability as compared to other system components), one option may be to inject a flowing “separation gas” (such as steam or inert gas) to create a pressure drop against the catalyst flow by flowing the “separation gas” up though a long catalyst inlet pipe in which catalyst flow is driven by gravity down towards the reactor. If P2>P2′, the process feed would flow down through the reactor and not up through the catalyst inlet pipe. However, to achieve this the pressure drop caused by separation gas flowing up though the incoming catalyst, the separation gas has to create a pressure drop significantly large to counter the pressure drops both through the reactor and through the regenerator. As recognized by the present inventors, there are at least three practical problems with this. For example, in order to develop sufficient pressure, P2, by flowing gas up through the catalyst inlet pipe, this pipe has to be excessively long to avoid the pressure gradient preventing the downward gravity driven catalyst flow. As another example, the separation gas (e.g., inert gas) delivering this pressure drop by flowing through the incoming catalyst is lost with the flue gas as is the thermal energy contained in it. As another example, thermal energy that could otherwise have been transferred with the regenerated catalyst from the regenerator is stripped out with the separation gas. In short, while this layout may appear appealing at first glance, it is not believed to be practical at industrial conditions.

As recognized by the present inventors, there is a need for processes that address the aforementioned issues when utilizing ketopyrolysis for lipid conversion to fuels, and that address the aforementioned issues when using traditional refinery processes for lipid conversion to fuels.

The examples discussed herein are directed to apparatus and methods for processing a lipid feedstock from alternative and renewable sources. The example apparatus and methods described herein are particularly beneficial in the oil and gas industry where lipid feedstocks can be used in the production of fuels. As will be described further below, the apparatus and methods described herein utilize a reactor system comprising ketopyrolysis and a moving bed reactor and a fluidized bed regenerator for treating lipid feedstocks within a refinery system.

### Definitions

The term “lipid” is known in the art and refers to fatty acids and their derivatives. Accordingly, examples of lipids include fatty acids (both saturated and unsaturated); glycerides or glycerolipids, also referred to as acylglycerols (such as monoglycerides (monoacylgycerols), diglycerides (diacylglycerols), triglycerides (triacylglycerols, TAGs, or neutral fats); phosphoglycerides (glycerophospholipids); nonglycerides (sphingolipids, sterol lipids, including cholesterol and steroid hormones, prenol lipids including terpenoids, fatty alcohols, waxes, and polyketides); and complex lipid derivatives (sugar-linked lipids or glycolipids, and protein-linked lipids). In some examples, the term “lipid” as used herein specifically refers to a fatty acid; glyceride (e.g., monoglyceride or diglyceride); glycerolipid (e.g., triglyceride, also referred to as triacylglycerol, TAG, or neutral fat); phospholipid; or phosphoglyceride (also known as glycerophospholipid).

As used herein, the term “fatty acid” is intended to refer to a monocarboxylic acid having an aliphatic chain containing about 3 to 39 carbon atoms, illustratively about 7 to 23 carbon atoms. The aliphatic chain may be linear or branched, and may be saturated (e.g., may contain no carbon-carbon double bonds) or may be unsaturated (e.g., may contain one or more carbon-carbon double bonds).

As used herein, a “lipid feedstock” is intended to refer to a composition which is derived from a biological source, rather than from a fossil fuel source such as crude oil, shale oil, or coal, and primarily contains lipids.

As used herein, the terms “renewable fuel intermediate composition” and “intermediate composition” are intended to refer to a liquid product that is produced from a lipid feedstock using a thermochemical process, and that may be further processed to generate a renewable fuel. In some examples, the intermediate compositions provided herein may include less than about 70 wt. % of an amount of oxygen in the lipid feedstock. An intermediate composition may include oxygenated hydrocarbons such as carboxylic acids, alcohols, ketones, aldehydes, and the like. In some examples, about 10 wt. % to 50 wt. % of the molecules of a liquid portion of the intermediate composition includes oxygen, and about 50 wt. % or more of the molecules of the liquid portion of the intermediate composition do not include oxygen. In some examples, at least about 80 wt. % of the oxygen in the liquid portion of the intermediate composition is within ketone groups.

As used herein, the term “pyrolysis” refers to the thermal decomposition of organic materials in an oxygen-lean atmosphere (i.e., significantly less oxygen than required for complete combustion).

As used herein, the term “ketopyrolysis” refers to a combined ketonization and pyrolysis process.

The term “hydroprocessing” generally encompasses all processes in which a hydrocarbon feedstock is reacted with hydrogen in the presence of a catalyst and under hydroprocessing conditions, typically, at elevated temperature and elevated pressure. Hydroprocessing includes, but is not limited to, processes such as hydrogenation, hydrodeoxygenation, hydrodesulfurization, hydrodenitrogenation, hydrodemetallization, hydrodearomatization, hydroisomerization, hydrodewaxing, hydrocracking and mild hydrocracking.

The term “fuels” encompasses “transportation fuels” and refers here to fractions or cuts or blends of hydrocarbons having distillation curves standardized for fuels, such as for diesel fuel (middle distillate from 160° C. to 380° C., according to EN 590), gasoline (40° C. to 210° C., according to EN 228), aviation fuel (160° C. to 300° C., according to ASTM D-1655 jet fuel), kerosene, naphtha, etc. Liquid fuels are hydrocarbons having distillation curves standardized for fuels, such as transportation fuels. When a transportation fuel is derived from a lipid feedstock (e.g., via an intermediate composition in a manner such as provided herein), then the transportation fuel may be referred to herein as a “renewable fuel.” When a fuel (such as a transportation fuel, e.g., renewable fuel) is ready for use without substantial further processing, it may be referred to herein as a “final product.” The final product may be conveyed to a site of use in any suitable manner, e.g., by pipeline, truck, and/or rail.

The term “ppm” means parts-per-million and is a weight relative parameter. A part-per-million is a microgram per gram, such that a component that is present at 10 ppm is present at 10 micrograms of the specific component per 1 gram of the aggregate mixture.

Lipid Feedstock Treatment with Moving Bed Reactors (MBRs)

As noted above, and as recognized by the present inventors, ketopyrolysis of lipid-containing feedstocks for conversion to fuel streams within refinery processes can have negative catalyst outcomes under certain circumstances, for example in the form of need for catalyst regeneration and caking of the catalyst bed. Specifically, ketopyrolysis removal of impurities within the low cost, low Cl feedstocks forms coke on the catalyst and has to be regenerated in a coke burn. In addition, the metals and phosphorous impurities are ejected in the catalyst bed and while they—unlike in traditional hydro processing—do not influence the ketopyrolysis catalyst activity, they can make the catalyst bed “cake” together.

Herein is described processes for lipid conversion to fuels employing a moving bed reactor (MBR) with a metal oxide catalyst that eliminates the undesirable effects of typical ketopyrolysis within refinery processes while conferring MBR benefits of lowered probability of catalyst particles caking together via catalyst mobility. Among other things, the present processes may allow continuous withdrawal, regeneration (coke burn) and returning of that catalyst in the ketopyrolysis process. Additionally, in examples including the moving bed layout with external regeneration, the regeneration reactor can be designed specifically for the purpose of regeneration. Alternatively, in examples in which regeneration is done in the same reactor as the reaction, the design has to accommodate both reaction and regeneration.

Some examples herein provide a process for converting a lipid feedstock to a fuel that includes ketopyrolysis of a lipid containing feedstock using a moving bed reactor system that achieves an operable valve-free moving bed reactor loop and reduces, eliminates, or avoids pressure loop problems that otherwise may be associated with the reactor and regenerator both flowing in the same direction around the loop as the catalyst. As recognized by the present inventors, such examples may be particularly challenging because process flows in the reactor and regenerator both flow in the same direction around the loop as the catalyst thereby creating pressure drops to be countered by other means.

Some examples herein provide a process for converting a lipid feedstock to a fuel that includes ketopyrolysis of a lipid containing feedstock using a moving bed reactor system that reduces, eliminates, or avoids pressure drop in the direction of the catalyst flow by flowing the process stream in cross flow in a radial converter reactor configuration.

### Lipid Feedstock

The lipid feedstocks described herein originate from a renewable or biological source or sources, and the lipid feedstocks are meant to include here feedstocks other than those obtained from mineral oil, shale oil, or coal. Depending on the source and the pretreatment (if any), a lipid feedstock may contain a mixture of different lipids. The lipid feedstock may for example comprise about 0 to 90 weight percent (wt. %) of free fatty acids, 5 to 100 wt. % fatty acid glycerol esters (e.g., monoglycerides, diglycerides, and/or triglycerides) and about 0 to 20 wt. % of one or more compounds selected from the list consisting of: fatty acid esters of the non-glycerol type, fatty amides, and fatty alcohols. In some examples, the renewable feedstock comprises more than 50 wt. % of free fatty acids and fatty acid glycerol esters, such as 70 wt. % or more of free fatty acids and fatty acid glycerol esters or more, for example 80 wt. % or more of free fatty acids and fatty acid glycerol esters, or more. The lipid feedstock may originate for example from plants, animals, algae (algae oil, algae biomass, algae cultivation), fish, and/or microbiological processes. Examples of such feedstocks include feedstocks originating from low value renewable waste materials, side streams, by-products, refining waste and residues, sewage sludge, and any combinations thereof.

In some examples, the lipid feedstock may be selected from the group consisting of acidulated soap-stocks, fatty acid distillates from physical refining of plant oils or animal fats, distillers corn oil (DCO) from ethanol production, waste cooking oils, lard, brown grease, yellow grease, trap grease, waste fats, low-grade oils, supercritical water liquefaction oils (SCWL oils), plant oils, animal fats and any combination thereof.

Such lipid feedstocks typically contain varying amounts of impurities, such as phosphorus, silicon, chloride, alkali metals, earth alkaline metals, other metals, etc.

In some examples, the lipid feedstock may comprise at least 10 ppm (e.g., 10 to 100 ppm, 10 to 75 ppm, 10 to 50 ppm, 15 to 100 ppm, or 15 to 50 ppm) of chlorine, calculated as elemental chlorine (a Cl atom). Chlorine content can be determined using combustion ion chromatography (CIC). Combustion ion chromatography is a technique in which a sample is burned in oxygen-containing gas flow, the gas generated is absorbed in an adsorption solution and then, a halogen ion adsorbed in the adsorption solution is quantitatively analyzed by an ion chromatography method. The technique makes it possible to easily analyze a halogen component in ppm range which has been conventionally difficult. In some examples, an organic chloride contaminant level can be determined by X-ray Fluorescence Spectroscopy, e.g., ASTM D7536-09, Standard Test Method for Chlorine in Aromatics by Monochromatic Wavelength Dispersive X-ray Fluorescence Spectrometry. Additionally, or alternatively, in some examples, chlorine content may be determined using X-ray fluorescence to determine chloride content with a detection limit of about 1 ppm.

Lipid feedstocks comprising one or more of alkali metals, alkaline earth metals, and/or other metals, such as iron and manganese, even in low amounts are often regarded as not suitable for catalytic treatment in refinery operations because each of the metals is an effective catalyst poison. The alkali metals, alkaline earth metals and other metals may typically comprise Na, K, Mg, Ca, Mn, Fc, or a combination thereof. The amount (if any) of metal, phosphorous, and/or certain other contaminants may be measured in any suitable manner, such as inductively coupled plasma-mass spectrometry (ICP).

In some examples, the lipid feedstock may comprise at least 1 ppm (e.g., 1 to 250 ppm, 1 to 100 ppm, 1 to 50 ppm, 1 to 25 ppm, 2 to 250 ppm, 2 to 100 ppm, or 2 to 25 ppm) of alkali metals, alkaline earth metals, metals of Groups VIIB and VIIIB, or combinations thereof, calculated as elemental metals, in total. Total metals content can be determined using AOCS Recommended Practice Ca 17-01.

Low value lipid feedstocks, such as various types of animal fats and waste oils, generally have a relatively high concentration of free fatty acids. One method of assessing the concentration of free fatty acids is to determine the total acid number (TAN) of the feedstock. The total acid number is the mass of potassium hydroxide (KOH) in milligrams that is required to neutralize one gram of the chemical substance being assessed. In some examples, the lipid feedstock may have an acid number of at least 5 mg KOH/g (e.g., 5 to 150 mg KOH/g, 10 to 150 mg KOH/g, 10 to 100 mg KOH/g, 10 to 50 mg KOH/g, from 10 to 25 mg KOH/g, or 10 to 20 mg KOH/g). Acid number can be determined using ASTMD664.

In some examples, the lipid feedstock may be pretreated. Such pretreatments include, but are not limited to, degumming, neutralization, bleaching, deodorizing, or any combination thereof.

### Treatment of Lipid Feedstock

As provided herein, a lipid feedstock (which optionally may be pretreated) may be treated using an MBR. In examples such as now will be described with reference to FIGS. 1, 2, 3, 4, 5, and 6A-6B, the process can comprise: a) treating a lipid feedstock comprising at least one fatty acid in a moving bed reactor with a metal oxide catalyst on an oxide support under treating conditions to produce a treated stream, wherein the treating conditions in the moving bed reactor include a temperature in a range of from 400° C. to 700° C., a pressure in a range from 0 to 10 MPa, and a liquid hourly space velocity, illustratively of about 0.1 to 10 h⁻¹.

The lipid feedstock may be reacted with the metal oxide catalyst under any suitable combination of reaction conditions to generate the intermediate composition. In various examples, the catalytic conversion may be performed at a temperature of about 400° C. to about 700° C., illustratively about 425° C. to about 600° C., e.g., about 450° C. to about 550° C., e.g., about 475° C. to about 500° C. Additionally, in some examples, the catalytic conversion may be performed at a pressure in the range of about 0.01 MPa to about 10 MPa, illustratively about 0.1 to about 5 MPa, e.g., about 0.1 to about 1 MPa. Additionally, in some examples, the catalytic conversion may be performed at a liquid hourly space velocity (LHSV) in the range of about 0.1 h⁻¹ to about 10 h⁻¹, illustratively about 0.2 h⁻¹ to about 5 h⁻¹, or about 0.3 h⁻¹ to about 3 h⁻¹, or about 0.5 h⁻¹ to about 1.5 h⁻¹. LHSV may be calculated as the volume of lipid feedstock per volume of catalyst per hour.

In some examples, the metal oxide catalyst includes at least one metal selected from the group consisting of Na, K, Mg, Ca, Sr, and a rare earth metal. Illustratively, the metal oxide catalyst may include at least one metal selected from the group consisting of Na, K, Ca, and Mg. In some examples, the metal of the metal oxide catalyst may be an alkali metal such as lithium, sodium, or potassium. In some examples, the metal of the metal oxide catalyst may be an alkaline earth metal such as magnesium, strontium, or calcium. In one nonlimiting example, the metal oxide catalyst may include calcium oxide, and in some examples may consist essentially of calcium oxide, or may consist of calcium oxide. The calcium within the calcium oxide catalyst may be in oxidation state 2 (as in CaO), but it may be in any suitable chemical form and is not limited to exclusively CaO. Additionally, the chemistry of the calcium oxide catalyst may change over time and/or with exposure to the lipid feedstock. For example, the calcium oxide catalyst initially may be in the form of CaO, CaO(OH), or Ca(OH)₂, or a mixture thereof. In operation, the calcium may be in the form of a mixture of any such compounds and/or in the form of carbonate or carboxylate. Additionally, or alternatively, the calcium may become partially embedded in the oxide support as aluminate, e.g., oxy-aluminate and/or hydroxy-aluminates. The metal oxide catalyst may be supported on any suitable oxide support, such as alumina. In some examples, the lipid feedstock is flowed over substantially no other solid-state materials besides the metal oxide catalyst (e.g., calcium oxide catalyst or other alkaline earth metal oxide catalyst) on the oxide support (e.g., alumina).

In some examples, the metal oxide catalyst on the oxide support may include (or in some cases may consist essentially of) particles with sizes in the range of about 0.05 mm to about 0.2 mm. The metal oxide catalyst on the oxide support additionally, or alternatively, may have any suitable combination of properties, e.g., bulk density, particle density, packed density, pore volume, large pore content, average pore diameter, and/or surface area. Illustratively, the metal oxide catalyst may have one or more of the following properties, or any suitable combination of two or more of the following properties: a bulk density in the range of about 0.78 kg/l to about 0.86 kg/l; a particle density in the range of about 1.2 kg/l to about 1.4 kg/l; a packed density in the range of about 0.8 g/cc to about 1.0 g/cc; a pore volume in the range of about 0.42 to about 0.48 cc/g; a large pore content (pores >1000 Å) of about 0.30 cc/g to about 0.38 cc/g; an average pore diameter (D50) of about 100 Å to about 200 Å; and/or a surface area of about 50 m²/g to about 150 m²/g. Additionally, or alternatively, the metal oxide catalyst may have one or more of the following properties, or any suitable combination of two or more of the following properties: a bulk density in the range of about 0.80 kg/l to about 0.84 kg/l; a particle density in the range of about 1.1 kg/l to about 1.3 kg/l; a packed density in the range of about 0.85 g/cc to about 0.95 g/cc; a pore volume in the range of about 0.44 to about 0.46 cc/g; a large pore content (pores >1000 Å) of about 0.33 cc/g to about 0.36 cc/g; an average pore diameter (D50) of about 130 Å to about 160 Å; and/or a surface area of about 80 m²/g to about 120 m²/g.

In some examples, the catalytic conversion of the lipid feedstock to the intermediate composition uses steam as an additional input to the reactor, e.g., in a manner such as will be described with reference to FIGS. 1, 2, 3, 4, 5, and 6A-6B. The steam may inhibit cracking and coke formation. In some examples, the steam is provided in an amount of about 0 wt. % to about 50 wt. %, and its use is optional. Some examples use substantially only steam and the lipid feedstock as inputs to the reactor for reactions which are catalyzed by the metal oxide catalyst on the oxide support. That is, hydrogen may not be separately input to the reactor. Additionally, the steam may not be a reactant in the reactions between the lipid feedstock and the metal oxide catalyst on the oxide support, e.g., may not be a source of hydrogen for such reactions.

A variety of MBR configurations may be used to implement such a process, some nonlimiting examples of which will now be described.

### Example Reactor Systems

As described above, in order to provide renewable feedstocks of bio-oils (also referred to herein as lipid feedstocks) suitable for refinery operations, the lipid feedstock is treated with a metal oxide catalyst to produce a treated stream. The treated stream can be condensed and fractionated into a gas fraction and a liquid fraction, wherein the liquid fraction comprises water and a processed bio-oil (also referred to herein as an intermediate composition) suitable for use as a renewable feedstock for hydroprocessing. Example reactor systems for treating lipid feedstocks to form processed bio-oils (intermediate compositions) will now be described in greater detail.

FIG. 1 schematically illustrates an example reactor system 100 that includes a catalyst flow within a moving bed reactor loop. In the nonlimiting example shown in FIG. 1, the catalyst flows down through the moving catalyst bed within reactor 110 driven by gravity to catalyst withdrawal line 112 which is coupled to fluid bed regenerator 120. The spent catalyst then is regenerated within fluid bed regenerator 120, and then flows up through riser 121 from the fluid bed regenerator 120 to the cyclone 130 at the top of the reactor 110, driven by the regenerator gas flow 160 (e.g., air). The catalyst then flows downward through catalyst feed line 113 into reactor 110. At the same time, the feed (lipid feedstock) 140 is injected at the top 111 of the reactor 110. Optionally, to inhibit coking, steam 180 may be co-introduced with lipid 140 and/or super-heated steam 190 may be introduced at a separate point within reactor 110. The process stream including the lipid feedstock being processed flows down through the moving catalyst bed catalyst bed within reactor 110 and is withdrawn as reactor effluent near the bottom of reactor 110 (product out 150 in FIG. 1). Such an arrangement may be referred to as a co-current downflow moving bed reactor which includes loop 110, 112, 120, 121, 130, 113.

As recognized by the present inventors, an example challenge in the lipid conversion process is to ensure that the total process flow does in fact travel down through the reactor and inhibit or prevent any process gas from escaping up through the cyclone. At the reaction conditions, a substantial part of the process flow will be in the gas phase and will create a substantial gas flow down through the catalyst bed causing a pressure drop in the reactor. Therefore, the pressure at the top of the reactor must be substantially higher than at the bottom of the reactor in order to drive the process flows in the downward direction. However, if the pressure at the top of the reactor is higher than in the pipe bringing the catalyst down from the cyclone, process gas will flow from the reactor up through the catalyst inlet pipe and into the cyclone and out with the flue gas 170 illustrated in FIG. 1.

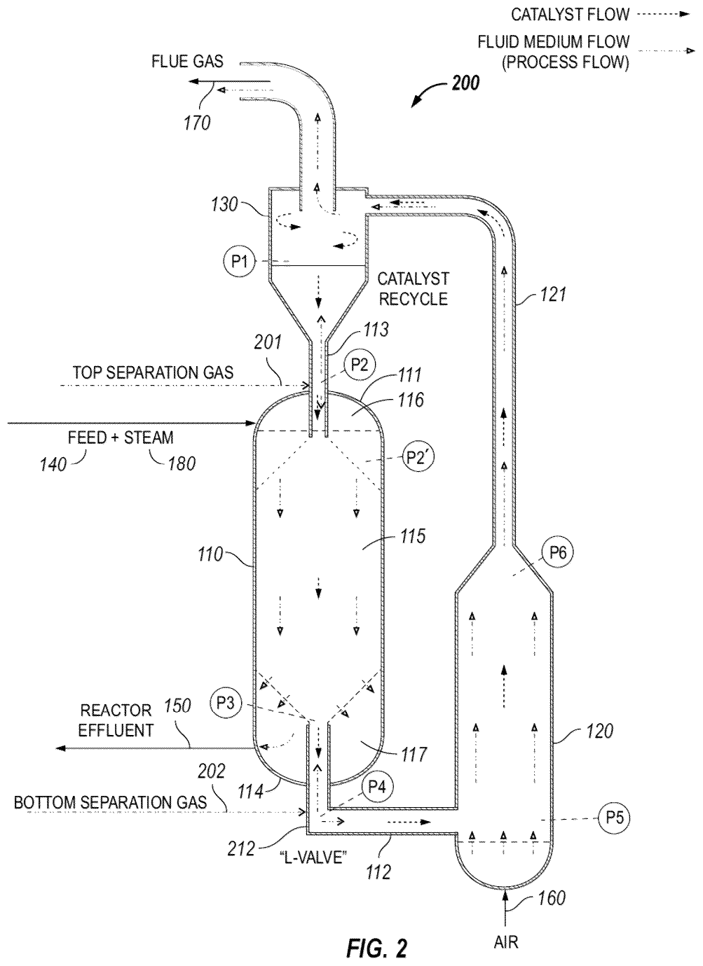

FIG. 2 schematically illustrates an example moving bed reactor system 200 that is a variation of FIG. 1 containing an “L”-valve 212, showing respective catalyst and process flow or “fluid medium” directions and select pressures in the catalyst loop. Certain aspects of the total process flow challenge are illustrated in FIG. 2, which presents example tracking pressures, and catalyst, process and steam flows around the loop. In this example, the process gas flow is driven by the pressure drop through the reactor 110, (P2′−P3) and it thus follows that P2′>P3. To inhibit or prevent process gas from flowing up in the catalyst feed line 113, P2′ must be no higher that P2 and preferably a little lower, (P2′≤P2). To ensure sufficient separation between the process gas 140, 180 in the top 111 of the reactor 110 and the regeneration flue gas 170 in the cyclone 130, a first separation gas 201 (such as steam or inert gas) may be injected into the pipe (catalyst feedline) 113 between the cyclone 130 and the top 111 of the reactor 110 to give a flow of first separation gas flowing up towards the cyclone 130 and thereby causing a pressure drop between the inlet of first separation gas 201 and the cyclone 130 (P2>P1). This pressure drop opposite the catalyst flow direction in the catalyst feed line 113 connecting the cyclone 130 to the top 111 of the reactor 110 helps support the pressure differential P2−P3 needed to drive the process flow through the reactor 110. However, the magnitude of the pressure differential, P2−P1, is limited by the need to keep the catalyst flowing down from the cyclone 130 to the reactor 110 via catalyst feedline 113. If this pressure difference P2−P1 becomes too big, then the returning of the regenerated catalyst from the cyclone 130 to the reactor 110 is slowed or prevented unless a mechanical device (such as a mechanical valve) allowing transport of catalyst against the pressure gradient is used. In addition, to create a large P2−P1 differential, a significant flow of first separation gas 201 may be needed, adding to the cost of the process.

Mechanical valves exist that would allow the catalyst to move against a pressure gradient between the cyclone 130 and reactor 110, but such mechanical devices are not great for long-term operability of the process and therefore not necessarily desirable.

Referencing the reactor system 200 of FIG. 2, if no mechanical device (e.g., mechanical valve) is used to allow catalyst flow against a pressure gradient, the pressures must drop through the loop 110, 112 (including 212), 120, 121, 130, 113 for the process stream to flow in the depicted direction. The only exceptions are flows up from separation gas injection points at the top 111 and bottom 114 of the reactor 110 that allows P2>P1 and P4>P3. Everywhere else around the loop 110, 112 (112 including 212), 120, 121, 130, 113, the pressure drops in the direction of the catalyst flow in the loop i.e. P2>P3, P4>P5, P5>P6 and P6>P1. Therefore, the reverse pressure drops in the separation zones 116 above and 117 below the active catalyst, P2−P1 and P4−P3 have to compensate for all the other pressure drops around the loop 110, 112 (including 212), 120, 121, 130, 113 indicating that P2−P1 and P4−P3 provide the driving force for process and regeneration gases flows in the loop. For a process like the lipid conversion process that produces relatively high volumes of vapor and gas at reaction conditions, this puts a relatively tight limitation on the feed flows and may severely limit productivity in the moving bed reactor. Another potential issue is that the separation gas 201 injected, beyond providing pressure drop, is essentially wasted. In the top 111 where separating gas flow provide the P2−P1 pressure driver, the separation gas 201 providing this is lost with the flue gas 170 as is the energy in terms of heat contained in the separation gas 201.

In some examples, a second separation gas 202 (e.g., steam or inert gas) also, or alternatively, may be injected near the bottom 114 of reactor 110 (e.g., within catalyst withdrawal line 112) to provide a pressure driver for the process flow. For example, as illustrated in FIG. 2, at a location near the bottom 114 where the separation gas 202 flows from the separation gas inlet point to the reactor bottom provides the pressure driver P4−P3. In this and other examples described herein, the second separation gas 202 may be of the same type of gas as the first separation gas 201, or may be of a different type of gas. The separation gas 202 may be ejected with the reactor effluent stream (product stream) 150 together with any energy contained in the separation gas 202. While energy lost as heat in these separation gas ejection streams 201, 202 may be recovered, such recovery would add to the heat transfer and heat recovery requirements for the process. It is therefore desirable to reduce or minimize the need for such separation gas flows.

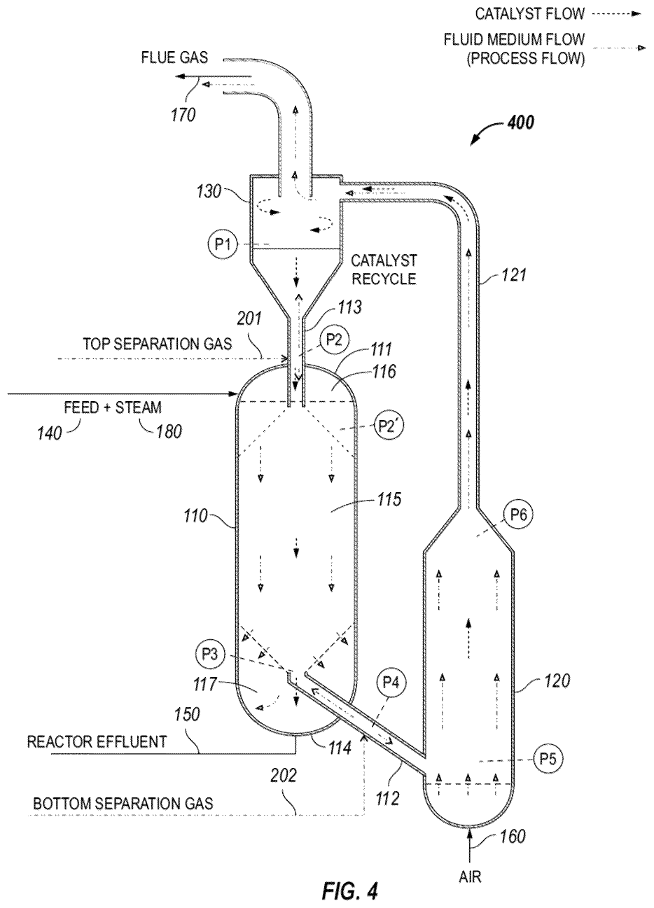

FIG. 4 schematically illustrates an example reactor system 400 that includes an optional stream of super-heated steam or quench stream, but that omits L-valve 221 and thus is expected to have significantly greater durability. Reactor system 400 may be configured similarly in some regards as reactor system 200, e.g., may include top separation gas 201 and bottom separation gas 202. However, while bottom separation gas 202 is injected into L-valve 212 in the example shown in FIG. 2, in FIG. 4 the bottom separation gas 202 is injected into catalyst withdrawal line 112 and used to establish a sufficient value of pressure P4 to promote the process flow to proceed in a manner similar to described further below. Here, the process loop may be expressed as 110, 112, 120, 121, 130, 113.

Moving Bed with Up Flow Process (Counter Current)

The above loop pressure analysis of FIG. 2 illustrates some of the challenges relating to achieve an operable valve-free moving bed reactor loop. A deeper analysis also shows that this is particularly challenging because process flows in the reactor 110 and regenerator 120 both flow in the same direction around the loop as the catalyst, thereby creating pressure drops to be countered by other means (e.g., using separation gas streams 201 and/or 202).

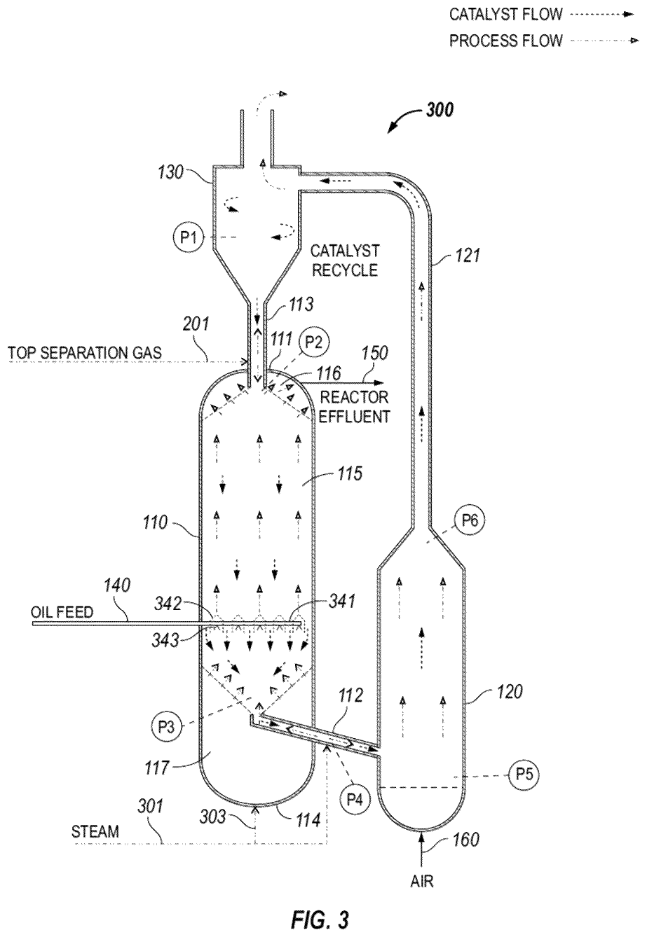

Some examples herein provide ketopyrolysis of a lipid feedstock using a moving bed reactor with counter current or “up flow” process. For example, FIG. 3 schematically illustrates an example moving bed reactor system 300 with an up-flow process stream. Referencing FIG. 3, system 300 is configured similarly to system 100 in some regards, but the process flow in the reactor 110 is reversed so that the process stream flows upwards in the reactor in the opposite direction of the slowly moving catalyst, i.e., in counter flow with the catalyst. Here the loop may be expressed as 110, 113, 130, 121, 120, 112. In this configuration, the process flow in the reactor 111 causes the pressure gradient through the reactor 110 to be in the opposite direction of the gravity driven catalyst flow, i.e., P3>P2. In this layout, the pressure drop over the reactor 110 (P3−P2) is largely compensated for by pressure drops over the fluid bed regeneration 120 (P5−P6) and over the riser 121 (P1−P6), making the loop operation less dependent on the pressure drops in the two separation zones, i.e., at the injection of separation gas 201 into catalyst feedline 113 (P2−P1) and at the injection of steam 301 into catalyst withdrawal line 112 (P4−P3).

In the nonlimiting example illustrated in FIG. 3, the feed stream (also referred to as an oil feed or lipid feedstock) 140, which may optionally be preheated, is injected into the lower part of the moving catalyst bed 115, instead of near the top 111 of reactor 110 as in FIGS. 1 and 2. The feed 140 may be injected through a flow distribution system 341 that allows feed distribution across the moving bed 115 cross-section of the reactor 110. Optionally the feed injection distribution system 341 provides provisions, e.g., conical members 342, to shield the feed injection nozzles 343 from direct physical contact with the moving bed catalyst 115. In some examples, superheated steam 301 is injected at a point further down the catalyst bed (not illustrated, but may be configured as described with reference to superheated steam 190 illustrated in FIG. 1) and/or at a point 303 from below the moving catalyst bed 115 as illustrated in FIG. 3). Though FIG. 3 shows steam 301 injected below the catalyst bed 115 and entering the bottom of the catalyst bed through a screen 304, it is within the scope that the steam 301 may be injected into the lower part of the bed 115 at a level below the injection level of the feed 140 using commonly known methods of distribution of inlet gas streams across a cross-section of the reactor 110. Optionally, the injection measures may include providence for inhibiting or preventing direct catalyst contact with injection nozzles.

As illustrated in FIG. 3, the injected steam 301 from point 303 drives the process flow up past the feed injection point 341 and towards the top 111 of the reactor 110 in counterflow with the catalyst, which is moving slowly down through the reactor 110. Reactor effluent 150 is drawn from at or near the top 111 of the reactor 110, and freshly regenerated catalyst is introduced at or near the top of the reactor 110 as shown in FIG. 3. Catalyst is withdrawn from the bottom 114 of the reactor 110 and transferred via catalyst withdrawal line 112 to a fluid bed regenerator 120, in which carbon deposits on the catalyst is burned off in the presence of a fluidizing gas stream 160 comprising air in a similar manner as described with reference to FIG. 1. The air flow in the regenerator 120 may be diluted with inert gas such as, for instance, nitrogen, recycled flue gas, or steam to control the exotherm in the coke burn. Similarly as described with reference to FIG. 1, the regenerated catalyst is transferred by pneumatic transport with the regeneration flue gas through a catalyst transfer line 121 to a cyclone 130 separating catalyst from flue gas 170, and returning the catalyst to reactor 110 via catalyst feed line 113.

As mentioned above, this layout allows for reducing or minimizing the need for separation gas flows for creating driving force for the flow around the loop 110, 113, 130, 121, 120, 112. In addition, by using steam 301 as separation gas injected in the catalyst withdrawal line 112 below the reactor 110 to provide the P4−P3 pressure differential, this steam 301 also serves as part of the steam flow driving the process direction up through the reactor 110. Any energy contained in this steam 301 is thus injected into the reactor 111 and not lost. By adjusting the amount (e.g., diverting more or less) of the total steam 301 injected at the bottom 114 of the reactor 110 (at point 303) to the catalyst transfer line 112, it is possible to adjust the pressure differential, P4−P3, thus compensating for pressure variations around the loop. This improves the operability of the moving bed converter 300.

While not shown in FIG. 3, it is within the scope to control the gravity driven catalyst flow out of the reactor 110 by such means as are known to people skilled in the art of solid particulate flows and their control, including by use of mechanical devices traditionally used to control flows of solid particulate materials. Likewise, it is within the scope to control the flow of catalyst from the cyclone 130 to the reactor 110 by mechanical device(s) or other means capable of controlling solid flows.

Moving Bed Lipid Conversion with Counter Flow, Up-Flow Regeneration

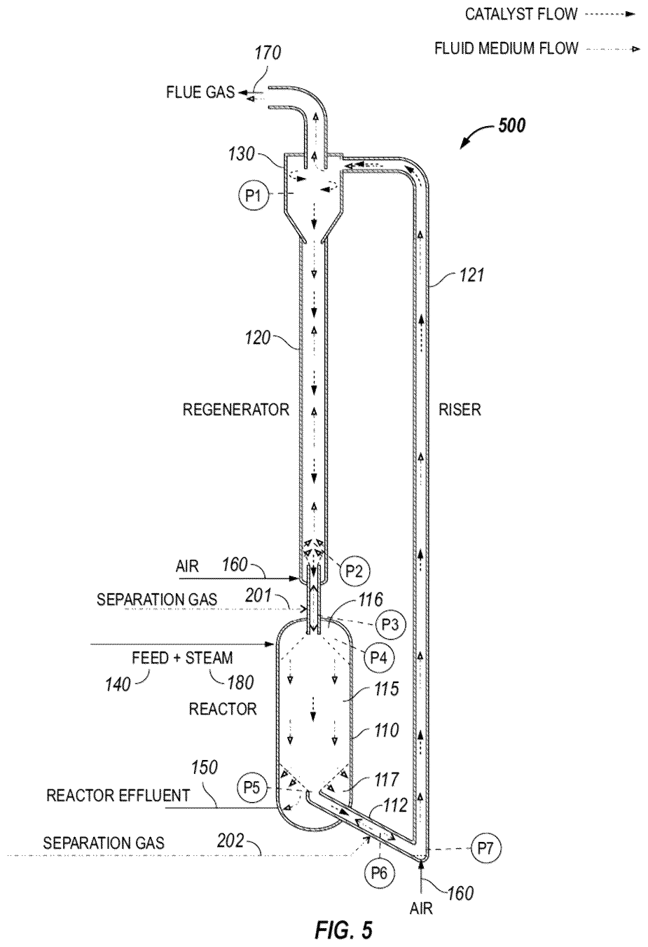

Some examples herein provide ketopyrolysis of a lipid feedstock using a moving bed reactor with counter flow, up-flow regeneration. For example, FIG. 5 schematically illustrates an example moving bed reactor system 500 with moving or fluid bed counter flow regeneration with gravity driven moving bed catalyst flow in both regenerator and reactor. Referencing FIG. 5, in this example, catalyst flow in the regenerator 120 is gravity driven and the regenerating gas flows in the opposite direction of the catalyst flow causing the pressure (P2), where the catalyst exits the regenerator 120 to be higher than the pressure (P1) where it enters the regenerator 120 from the cyclone 130 that separates catalyst from pneumatic transfer line 121. The pressure drop over the regenerator 120 (P2−P1) thereby assists in providing driving pressure for the gas flow through the reactor 110 (P4−P5), thereby lowering the need to create driving pressure differential in the separation zone above 116 (P3−P2) and below 117 (P6−P5) the reactor 110.

Variation in air flow up though the regenerator 120 as well as catalyst level in the regenerator 120 are variables that can be used to tune the driving pressure (P2−P1) delivered by the regenerator 120 to compensate for variations in pressure drop over the reactor 110. Since both air flow and catalyst levels are variables that may be changed during operation, this provides a tool for balancing the pressures in the catalyst loop 110, 112, 121, 130, 120, 113 and improves its operability relative to the process depicted in FIG. 1 and FIG. 4.

In the example layout depicted in FIG. 5, another potential advantage is that some of the coke on the catalyst may be burned in the riser 121 and in the cyclone 130 despite the very short residence time in this part (121, 130) of the loop. Any coke burned in the riser 121 and cyclone 130 would not contribute to the heat produced in the regenerator. This would lower the need to temperature moderating measures such as dilution of the regeneration air with inserts such as nitrogen, steam, or recycled flue gas.

While not shown in FIG. 5, it is within the scope that the flow of catalyst from the reactor 110 to the riser 121 (via catalyst withdrawal line 112) and from the regenerator 120 to the reactor 110 (via catalyst feedline 113) may be adjusted by mechanical device(s) and/or other means capable of controlling flows of particulate solids.

### Cross Flow Moving Bed-Radial Converter

Other examples herein provide ketopyrolysis of a lipid feedstock using a cross flow/radial converter moving bed.

The loop pressure analysis of FIG. 2 illustrates example challenges relating to achieve an operable valve-free moving bed reactor loop. A deeper analysis also shows that this is particularly challenging because process flows in the reactor 110 and regenerator 120 flow in the same direction around the loop as the catalyst, thereby creating pressure drops to be countered by other means (e.g., separation gases 201 and 202).

An example issue around pressure drop in the direction of the catalyst flow is reduced or avoided by flowing the process stream in cross flow in a reactor configuration traditionally referred to as a radial converter. In a moving bed radial converter, such as previously described in Shirzad et al., “Moving Bed Reactors, Challenges and Progress of Experimental and Theoretical Studies in a Century of Research” Ind. Eng. Chem. Res. 58(22): 9179-9198 (2019), the catalyst is slowly moving down through the reactor from top to bottom, the flow being driven by gravity and limited by solid flow restrictions at the catalyst outlet. At the catalyst outlet, the catalyst is withdrawn from the reactor to be regenerated outside the reactor before being returned to the top of the reactor as regenerated catalyst. The process stream flows perpendicular to the flow direction of the catalyst and the pressure drop caused by the passage of the process stream through the catalyst bed is thus in a radial direction and does not contribute to pressure difference in the longitudinal direction between top and bottom of the catalyst bed.

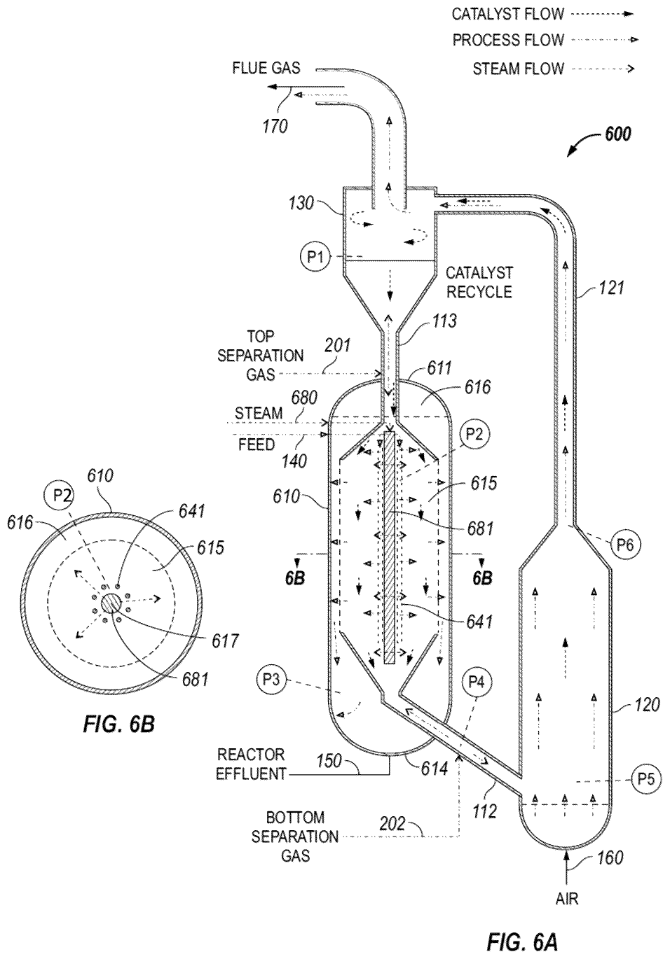

FIGS. 6A-6B schematically illustrate an example process for lipid conversion in a moving bed radial converter system 600 with process stream flowing outwards from the axis of the reactor 610 towards the periphery. Referencing FIGS. 6A-6B, this example concerns a lipid conversion process using a particulate catalyst comprising a metal oxide on an oxide support (such a catalyst also may be used in all of the other examples described with reference to FIGS. 1, 2, 3, 4, and 5). According to this example, in which other components may be configured similarly as described with reference to FIGS. 1, 2, and 4, the lipid conversion takes place in a radial flow moving bed reactor 610, in which the catalyst slowly flows vertically from top 611 to bottom 614, while the process stream (fluid medium flow) flows horizontally across the catalyst bed 615. As shown in the cross-sectional view of FIG. 6B, the process flow directions may be either from the periphery 616 of the catalyst bed 615 and inwards towards the center axis 617 of the reactor 610, or from the center of the reactor 617 flowing outwards towards the periphery 616 (this flow not specifically illustrated). While both inwards and outwards flows are within the scope of this example, in some cases the preferred flow direction is outwards from the center 617, because the lipid feed 140 has a high molecular weight and is partially in the liquid phase while the products 150 are gaseous and has much lower average molecular weight causing the process stream to undergo a dramatic volume increase as it passes through the reactor. An added benefit of this outwards cross flow compared to up- or down-flow is a much lower pressure drop, which saves energy for the total process.

Traditionally, moving bed radial flow converters are used for processing single phase gas streams (continuous catalytic reforming (CCR) naphtha reforming technology is an example). In the lipid conversion process according to certain examples herein (e.g., as described with reference to FIGS. 1, 2, 3, 4, and 5), even if the reactor feed 140 is pre-heated to near reaction temperature, much of the reactor feed 140 will be in the liquid phase and it is a challenge to ensure good lipid feed distribution along the central axis 617 of the moving bed reactor. FIGS. 6A-6B illustrate one reactor configuration according to some examples that ensures such distribution. For example, steam 680 is injected through a steam distributer 681 running along the center axis 617 of the reactor 610 in such a way that the steam flow is relatively evenly distributed along the length and circumference of the steam distributer 681. The lipid feed 140, optionally pre-heated, is injected through a feed distribution system 641 that ensures that injection of the feed stream 140 into the moving catalyst bed 615 is relatively evenly distributed along the circumference of and along the length of the steam distributer 681 at a relatively short distance from said steam distributer 681. One possible configuration of said feed distribution system 641 as shown in FIGS. 6A-6B is in form of narrow pipes evenly distributed around the circumference of the steam distributer 681 and fitted with small holes or nozzles allowing feed flow into the catalyst bed 615 along the length of each pipe. Optionally, the feed injection distribution system 641 provides provisions (e.g., a perforated cylindrical member) to shield the feed injection nozzles 642 from direct physical contact with the moving bed catalyst 615.

Alternative modes known to one of skill in the art of steam distribution and feed along and around the center axis 617 as well as the length of the reactor are within the scope of the present examples.

Particular example features of lipid conversion in a moving bed radial converter 600 with process stream flowing outwards from the axis 617 of the reactor 610 towards the periphery 616 are demonstrated in FIGS. 6A-6B.

In some examples, referencing FIGS. 6A-6B, the catalyst is withdrawn at or near the bottom 614 of the reactor 610, transferred via catalyst withdrawal line 112 to a fluid bed regenerator 120, where coke is removed by burning in a regeneration stream comprising air 160 optionally mixed with steam and/or another inert diluent to control the regeneration exotherm. From the fluid bed regenerator 120 the regenerated catalyst is transferred to the top 611 of the reactor 610 by pneumatic transfer through a catalyst transfer line 113 and separated from the regeneration flue gas 170 in a cyclone 130 designed to separate out only catalyst particles above a certain size, e.g., in a manner such as described elsewhere herein. In FIGS. 6A-6B and other examples herein, dust from catalyst attrition and dust formed in the process from the feed is ejected with the flue gas 170 and collected in traditionally dust collecting devices (cyclones, filter bags, electrostatic filters and/or other) processing on the catalyst-free flue gas (not shown in FIGS. 6A-6B).

Referencing FIGS. 6A-6B, the pressure drop for the process stream over the catalyst bed 615 (P2−P1) in this layout is substantially less than in up- or down-flow as mentioned earlier but there is a need for some pressure drop to control relatively even flow distribution of steam and feed and this will add to the overall process stream pressure drop over the reactor 610. In a manner such as described elsewhere herein, the pressure drop over the regenerator 120 (P5−P6) and over the catalyst transfer 121 (P1−P6) are compensated for by pressure drop (P4−P3) caused by separation gas 202, optionally steam, injected into the line 112 transferring catalyst from the bottom of the reactor 610 to the regenerator 120 and flowing into the reactor 610 in the opposite direction of the catalyst flow. Besides creating the pressure needed to compensate for pressure drop in the catalyst regeneration and recycle system 120, 121, the separation gas 202 injected into this transfer line 112 also serves to strip out residual oil (feed) from the spent catalyst and returning this oil to the reactor and thereby to the product stream (reactor effluent) 150. The catalyst flow in and out of the reactor 610 may be controlled by flow restrictions and controls traditionally used for such service such as for instance solid transfer valves. Convenient position for such catalyst flow controlling devices in the catalyst loop 610, 112, 120, 121, 130, 113 are in the catalyst transfer line between the cyclone 130 and the reactor 610 and/or in the catalyst transfer line 112 between the bottom 614 of the reactor and the regenerator 120. Catalyst flow control measures are within the scope of the present examples even though they are not shown in FIGS. 6A-6B.

To inhibit or prevent mixing of process gas 150 and regeneration flue gas 170, in some examples separation gas 201 is injected into the line 113 transferring catalyst from the cyclone 130 to the reactor 610. This separation gas 201 may be steam, recycled flue gas, nitrogen or other gas that is not damaging if vented with the flue gas.

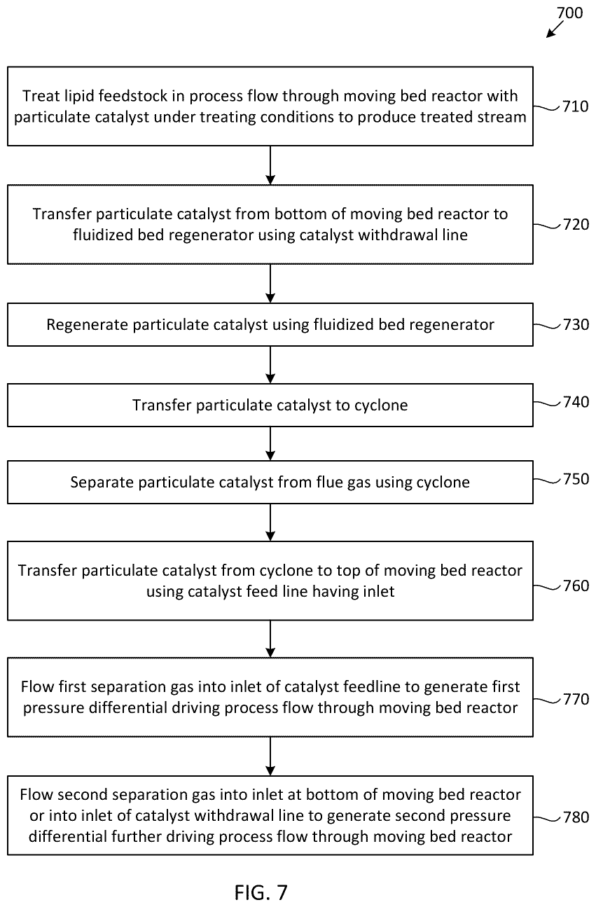

It will be appreciated that the present processes may be implemented using any suitable systems such as, but not limited to, those described with reference to FIGS. 2, 3, 4, 5, 6A, and 6B. For example, FIG. 7 illustrates an example flow of operations in a process for converting a lipid feedstock to a renewable fuel intermediate composition using a moving bed reactor. Process 700 illustrated in FIG. 7 may include treating a lipid feedstock in a process flow through a moving bed reactor with a particulate catalyst under treating conditions to produce a treated stream (operation 710). In some examples, the moving bed reactor includes a top and a bottom. In some examples, the lipid feedstock comprises at least one fatty acid. In some examples, the particulate catalyst includes a metal oxide catalyst on an oxide support. Nonlimiting examples of moving bed reactors suitable for use in operation 710 include reactor 111 described with reference to FIG. 2, reactor 111 described with reference to FIG. 3, reactor 111 described with reference to FIG. 4, reactor 111 described with reference to FIG. 5, and reactor 611 described with reference to FIGS. 6A-6B. Nonlimiting examples of lipid feedstocks that may be treated using operation 710 are described elsewhere herein. Nonlimiting examples of particulate catalysts suitable for use in operation 710 are described elsewhere herein.

Process 700 illustrated in FIG. 7 further may include transferring the particulate catalyst from the bottom of the moving bed reactor to a fluidized bed regenerator using a catalyst withdrawal line (operation 720). Nonlimiting examples of transfer processes, and catalyst withdrawal lines, suitable for use in operation 720 include catalyst withdrawal line 112 (including L-valve 212) described with reference to FIG. 2, catalyst withdrawal line 112 described with reference to FIG. 3, catalyst withdrawal line 112 described with reference to FIG. 4, catalyst withdrawal line 112 described with reference to FIG. 5, and catalyst withdrawal line 112 described with reference to FIGS. 6A-6B. In some examples, the transfer of the particulate catalyst to the fluidized bed regenerator may be performed using solely the catalyst withdrawal line, for example in a manner such as described with reference to FIGS. 2, 3, 4, and 6A-6B. In other examples, the transfer of the particulate catalyst to the fluidized bed regenerator also may be performed using one or more other components. Illustratively, in a manner such as described with reference to FIG. 5, the particulate catalyst may be transferred from the bottom 114 of moving bed reactor 111 via catalyst withdrawal line 112, riser 121, and cyclone 130.

Process 700 illustrated in FIG. 7 further may include regenerating the particulate catalyst using the fluidized bed regenerator (operation 730). Nonlimiting examples of regeneration processes, and fluidized bed regenerators, suitable for use in operation 730 include fluidized bed regenerator 120 described with reference to FIG. 2, fluidized bed regenerator 120 described with reference to FIG. 3, fluidized bed regenerator 120 described with reference to FIG. 4, fluidized bed regenerator 120 described with reference to FIG. 5, and fluidized bed regenerator 120 described with reference to FIGS. 6A-6B.

Process 700 illustrated in FIG. 7 further may include transferring the particulate catalyst to a cyclone (operation 740). Nonlimiting examples of transferring processes, and structures, suitable for use in operation 740 include riser 121 described with reference to FIG. 2, riser 121 described with reference to FIG. 3, riser 121 described with reference to FIG. 4, riser 121 described with reference to FIG. 5, and riser 121 described with reference to FIGS. 6A-6B. In some examples, the particulate catalyst may be transferred from the fluidized bed regenerator to the cyclone 130 using riser 121, for example as described with reference to FIGS. 2, 3, 4, and 6A-6B. In other examples, the particulate catalyst may be transferred from the reactor 110 to the cyclone 130 using riser 121 (and optionally also catalyst withdrawal line 112), for example as described with reference to FIG. 5.

Process 700 illustrated in FIG. 7 further may include separating the particulate catalyst from flue gas using the cyclone (operation 750). Nonlimiting examples of separating processes, and structures, suitable for use in operation 750 include cyclone 130 described with reference to FIG. 2, cyclone 130 described with reference to FIG. 3, cyclone 130 described with reference to FIG. 4, cyclone 130 described with reference to FIG. 5, and cyclone 130 described with reference to FIGS. 6A-6B.

Process 700 illustrated in FIG. 7 further may include transferring the particulate catalyst from the cyclone to the top of the moving bed reactor using a catalyst feed line having an inlet (operation 760). Nonlimiting examples of transferring processes, and catalyst feed lines, suitable for use in operation 760 include catalyst feedline 113 described with reference to FIG. 2, catalyst feedline 113 described with reference to FIG. 3, catalyst feedline 113 described with reference to FIG. 4, catalyst feedline 113 described with reference to FIG. 5, and catalyst feedline 113 described with reference to FIGS. 6A-6B.

Process 700 illustrated in FIG. 7 further may include flowing a first separation gas into the inlet of the catalyst feedline to generate a first pressure differential driving the process flow through the moving bed reactor (operation 770). Nonlimiting examples of such processes, and structures, suitable for use in operation 770 are described with reference to the process flows of FIGS. 2, 3, 4, 5, and 6A-6B.

Process 700 illustrated in FIG. 7 further may include flowing a second separation gas into an inlet at the bottom of the moving bed reactor or into an inlet of the catalyst withdrawal line to generate a second pressure differential further driving the process flow through the moving bed reactor (operation 780). Nonlimiting examples of such processes, and structures, suitable for use in operation 770 are described with reference to the process flows of FIGS. 2, 3, 4, 5, and 6A-6B.

In some examples, the cyclone is operationally located between the fluidized bed regenerator and the moving bed reactor, for example in a manner such as described with reference to FIGS. 2, 3, 4, and 6A-6B.

Additionally, or alternatively, in some examples, the particulate catalyst flows in a same direction as the process flow, for example in a manner such as described with reference to FIGS. 2 and 4. Alternatively, in some examples, the particulate catalyst flows in an opposite direction as the process flow, for example in a manner such as described with reference to FIG. 3.

Additionally, or alternatively, some examples include flowing the second separation gas into both the bottom of the moving bed reactor and into the inlet of the catalyst withdrawal line to further drive the process flow through the moving bed reactor, for example in a manner such as described with reference to FIG. 3.

Additionally, or alternatively, in some examples the process flow does not pass through a valve (such as an L-valve), for example in a manner such as described with reference to FIGS. 3, 4, 5, and 6A-6B.

Additionally, or alternatively, in some examples the first separation gas may include steam or an inert gas, for example in a manner such as described with reference to FIGS. 2, 3, 4, 5, and 6A-6B.

Additionally, or alternatively, in some examples the second separation gas may include steam or an inert gas, for example in a manner such as described with reference to FIGS. 2, 3, 4, 5, and 6A-6B.

Additionally, or alternatively, in some examples the particulate catalyst is transferred from the fluidized bed regenerator to the cyclone using a riser having a first end coupled to the fluidized bed regenerator and a second end coupled to the cyclone, for example in a manner such as described with reference to FIGS. 2, 3, 4, and 6.

Additionally, or alternatively, in some examples the lipid feedstock is input at the top of the fluidized bed regenerator, for example in a manner such as described with reference to FIGS. 2, 4, 5, and 6.

Additionally, or alternatively, in some examples the lipid feedstock is input between the top and the bottom of the fluidized bed regenerator, for example in a manner such as described with reference to FIG. 3.

Additionally, or alternatively, in some examples the moving bed reactor includes a radial converter, and the process flow includes flow of the product stream from a central axis of the radial converter to a periphery of the radial converter, for example in a manner such as described with reference to FIG. 6.

Additionally, or alternatively, in some examples, the particulate catalyst is in a cross-flow to the flow of the product stream, for example in a manner such as described with reference to FIG. 6.

Additionally, or alternatively, in some examples, the fluidized bed regenerator is operationally located between the cyclone and the moving bed reactor, for example in a manner such as described with reference to FIG. 5. In some examples, the particulate catalyst flows in a same direction as the process flow within the moving bed reactor, for example in a manner such as described with reference to FIG. 5. Additionally, or alternatively, in some examples the particulate catalyst flows in an opposite direction as the process flow within the fluidized bed regenerator, for example in a manner such as described with reference to FIG. 5. Additionally, or alternatively, in some examples, the catalyst withdrawal line has a first end coupled to the bottom of the moving bed reactor, and a second end. The particulate catalyst may be transferred from the moving bed reactor to the cyclone using (i) the catalyst withdrawal line; and (ii) a riser having a first end coupled to the second end of the catalyst withdrawal line, and a second end coupled to the cyclone, for example in a manner such as described with reference to FIG. 5.

Additionally, or alternatively, in some examples the treated stream is withdrawn from the bottom of the moving bed reactor, for example in a manner such as described with reference to FIGS. 2, 4, 5, and 6A-6B.

Additionally, or alternatively, in some examples the treated stream is withdrawn from the top of the moving bed reactor, for example in a manner such as described with reference to FIG. 3.

Additionally, or alternatively, in some examples, the treated stream comprises a renewable fuel intermediate composition, for example in a manner such as described with reference to FIGS. 2, 3, 4, 5, and 6A-6B.

Additionally, or alternatively, in some examples, one or more hydroprocessing steps are performed. In some examples, the one or more hydroprocessing steps are selected from the group consisting of: hydrogenation, double bond saturation, hydrodeoxygenation, hydrocracking, hydro-isomerization, hydrodesulfurization, hydrodenitrogenation, hydrodearomatization, hydrodewaxing, and mild hydrocracking. Such hydroprocessing may be performed, for example, using a hydroprocessor such as known in the art.

Additionally, or alternatively, in some examples, the metal oxide catalyst includes at least one metal selected from the group consisting of Na, K, Mg, Ca, and Sr. In some examples, the metal oxide catalyst includes at least one metal selected from the group consisting of Na, K, Ca, and Mg.

Additionally, or alternatively, in some examples, the metal oxide catalyst includes calcium oxide.

Additionally, or alternatively, in some examples, the oxide support comprises alumina.

Additionally, or alternatively, in some examples, wherein the metal oxide catalyst on the oxide support comprises particles with sizes in the range of about 0.05 mm to about 0.2 mm.

Additionally, or alternatively, in examples in which the treated stream includes a renewable fuel intermediate composition, the renewable fuel intermediate composition may include less than about 70 wt % of an amount of oxygen in the high-phosphorous lipid feedstock.

Additionally, or alternatively, in examples in which the treated stream includes a renewable fuel intermediate composition, the renewable fuel intermediate composition may include a mixture of organic compounds primarily having a boiling point above about 150° C.

Additionally, or alternatively, in examples in which the treated stream includes a renewable fuel intermediate composition, a fraction of the renewable fuel intermediate composition may be hydroprocessed to aviation fuel, diesel, naphtha, or gasoline. Such hydroprocessing may be performed, for example, using a hydroprocessor such as known in the art.

Additionally, or alternatively, in some examples, the treating conditions in the moving bed reactor include a temperature in a range of from 400° C. to 700° C., a pressure in a range from 0 to 10 mPa, and a liquid hourly space velocity in a range from 0.1 to 10 h⁻¹.

### Intermediate Compositions and Renewable Fuels Generated Using the Same

The reaction(s) performed using the metal oxide catalyst may reduce the amount of oxygen in the lipid feedstock. For example, the intermediate composition may include less than about 70 wt. % of an amount of oxygen in the lipid feedstock. Additionally, the reaction(s) performed using the metal oxide catalyst may modify the location(s) of oxygen within the molecules being reacted. For example, at least about 80 wt. % of the oxygen in the liquid portion of the intermediate composition may be within ketone groups. In comparison, in some examples, the lipid feedstock substantially may not include any ketone groups.

In some examples, the intermediate composition includes a mixture of organic compounds primarily having a boiling point above about 150° C. The renewable fuel intermediate composition may be stored and/or may be further processed in any suitable manner to form a final product (e.g., renewable fuel). Illustratively, method 700 illustrated in FIG. 7 further may include hydroprocessing a fraction of the intermediate composition to aviation fuel. Additionally, or alternatively, method 700 illustrated in FIG. 7 further may include hydroprocessing a fraction of the intermediate composition to renewable diesel fuel. Additionally, or alternatively, method 700 illustrated in FIG. 7 further may include hydroprocessing a fraction of the intermediate composition to renewable naphtha. Additionally, or alternatively, method 700 illustrated in FIG. 7 further may include hydroprocessing a fraction of the intermediate composition to renewable gasoline. Such hydroprocessing may be performed using any suitable hydroprocessor, for example such as known in the art.

Previously known approaches to hydrotreating lipids typically produce a majority of hydrocarbons in the diesel fuel range with very little in the jet fuel range. However, it has been further discovered that ketopyrolysis such as described with reference to FIGS. 1, 2, 3, 4, 5, 6A-6B, and 7 may be used to produce a renewable fuel intermediate composition that is surprisingly lighter and richer in components in the jet fuel range. Without being bound by a particular theory, it is believed that in ketopyrolysis, heavier components of the intermediate composition that have a boiling point that is too high for evaporation under the conditions in the moving bed reactor tend to remain in the liquid phase in the moving bed reactor until they convert further into lighter products that evaporate in the moving bed reactor and are carried out of the moving bed reactor with the treated stream. It is further understood that ketopyrolysis restructures the carbon chains in the fatty acids of the lipids. In some examples, the intermediate composition is or includes a mixture of essentially non-acidic hydrocarbons and oxygenates, primarily ketones, with chain lengths varying from significantly shorter than the original fatty acid chain length to considerably longer than the original fatty acid chain length. This phenomenon yields a renewable fuel intermediate composition that is particularly useful for producing fuel range products, particularly products in the aviation fuel range.

In some examples, the intermediate composition exiting the moving bed reactor may be separated into the following components: 1) renewable fuel gas including (and, in some examples, consisting essentially of) C1 and C2 hydrocarbons with a boiling point range of about 0° C. to about 20° C., 2) a renewable liquefied petroleum gas (LPG) including (and, in some examples, consisting essentially of) C3 and C4 hydrocarbons with a boiling point range of about 20° C. to about 150° C., 3) a renewable intermediate transportation fuel including (and, in some examples, consisting essentially of) hydrocarbons in the range of C5 to C20 with a boiling point range of about 150° C. to about 360° C., and 4) a heavy ends product including (and, in some examples, consisting essentially of) hydrocarbons in the range of C21 to C35 with a boiling point range of about 360° C. to about 490° C. Such separation may be performed, for example, using distillation in a manner such as known in the art.

In some examples, such separation may be used to obtain a liquid portion of the renewable fuel intermediate composition having the following characteristics:
(1) naphtha (boiling point of about 20° C. to about 150° C.) of greater than 10 wt % and less than about 30 wt. % in the intermediate composition;
(2) intermediate transportation fuel (boiling point of about 150° C. to about 360° C.) of greater than about 40 wt. % and less than about 60 wt. % in the intermediate composition; and
(3) heavy ends product (boiling point of about 360° C. to about 490° C.) of less than about 30 wt. % in the intermediate composition.

In some examples, the liquid portion of the renewable fuel intermediate composition may be further characterized as having greater than 90% of its carbon content being renewable carbon of biological (as opposed to fossil/mineral) origin as measured by standard C14 radiocarbon analysis.

In some examples, the liquid portion of the renewable fuel intermediate composition may be further, or alternatively, characterized as having an oxygen content in the range of 1-4 wt. %.

In some examples, the liquid portion of the renewable fuel intermediate composition can be further, or alternatively, characterized as having an NMR branching index of greater than about 14%, wherein the NMR branching index is defined as the integral of the protons in the methyl region of 0.5 to 0.95 ppm as a percentage of the integral of the entire aliphatic proton resonances region of 0.5 to 2.1 ppm.

In some examples, the liquid portion of the renewable fuel intermediate composition may be further, or alternatively, characterized as having about 10 wt. % to about 50 wt. % of oxygen containing molecules and/or at least about 50 wt. % of oxygen-free hydrocarbons.

In some examples, the liquid portion of the renewable fuel intermediate composition can be further, or alternatively, characterized as having more than about 80 wt. % of the oxygen in the product being in the form of ketone groups. Additionally, or alternatively, in some examples, the liquid portion of the renewable fuel intermediate composition may be characterized as having and at least about 10 wt. % of the oxygen in the form of methyl ketones (Me-C(O)—R).

In some examples, the liquid portion of the renewable fuel intermediate composition can be further, or alternatively, characterized as having a total acid number (TAN) of less than 1.

In one nonlimiting example, an intermediate aviation fuel portion of the liquid renewable fuel intermediate composition that is suitable for further processing into aviation fuel (e.g., jet fuel) may be characterized as:
(1) having greater than 90% of its carbon content being renewable carbon of biological (as opposed to fossil/mineral) origin as measured by standard C14 radiocarbon analysis;
(2) having a freezing point of less than about −15° C.;
(3) having less than about 10 wt. % of its content comprising acyclic isoalkanes; and
(4) having greater than about 15 wt. %, (e.g., greater than about 20 wt. %, or greater than about 30 wt. %) of its content being saturated hydrocarbons with one or two rings (i.e., cycloalkanes).

In some examples, the intermediate aviation fuel portion can be further, or alternatively, characterized as a composition in which the fraction of saturated hydrocarbons with one or two rings is at least twice the fraction of saturated acyclic hydrocarbons (i.e., traditional isoalkanes).

In some examples, the intermediate aviation fuel portion can be further characterized as a composition in which the fraction of saturated hydrocarbons with one or two rings is larger than the fraction of saturated acyclic hydrocarbons (i.e., traditional isoalkanes).

As noted above, transportation fuels have to meet certain specifications. The cold flow properties of transportation fuels may be particularly challenging when making renewable fuels from lipid feedstock. For example, lipids may include linear molecular components which, in previously known methods, tend to hydrotreat to predominantly linear products, which may have relatively high pour, cloud, and freeze points. Consequently, renewable fuels produced using previously known methods may need extensive isomerization/isodewaxing to meet the cold flow property specification. The specifications for aviation fuels, in particular, have a relatively low freeze point (i.e., −40° C. for Jet A, −47° C. for Jet A-1, and −60° C. for Jet B).

In some examples, intermediate compositions made using the present systems and methods may be used to produce a hydrotreated renewable fuel composition that is suitable for use as transportation fuel (particularly jet fuel, such as Jet A or Jet A-1). For example, it is expected that when the renewable fuel intermediate composition is hydrogenated, the jet fuel range fraction of the hydrogenated product will have a suitable freezing point. In one nonlimiting example, the hydrotreated renewable fuel composition may be characterized as having:
(1) a carbon content of which at least about 90% is derived from biological origin as determined by carbon-14 presence;
(2) a bromine index less than about 1000;
(3) an oxygen content less than about 1 wt. %; and
(4) a cycloalkane content having one or two rings, the cycloalkane content comprising greater than 15 wt. %.

In some examples, the hydrotreated renewable fuel composition may be further, or alternatively, characterized as having a jet fuel component that has a freezing point less than about −15° C., or less than about −20° C., or less than about −30° C., or less than about −40° C., or about −40° C., or about −47° C.

In some examples, the hydrotreated renewable fuel composition may be further, or alternatively, characterized as having an n-alkane content of less than about 70 wt. %, or less than about 60 wt. %.

In some examples, the hydrotreated renewable fuel composition may be further, or alternatively, characterized as having an acyclic isoalkane content of less than about 15 wt. %.

In some examples, the hydrotreated renewable fuel composition may be further, or alternatively, characterized as having a cycloalkane content that is at least about twice an acyclic isoalkane content as measured by weight percent of the hydrotreated renewable fuel composition.

In some examples, The hydrotreated renewable fuel composition may be further, or alternatively, characterized as having mono-aromatic components greater than about 2 wt. % and less than about 15 wt. %.

### Additional Comments

Values, ranges, or features may be expressed herein as “about”, from “about” one particular value, and/or to “about” another particular value. When such values, or ranges are expressed, other embodiments disclosed include the specific value recited, from the one particular value, and/or to the other particular value, or similarly, when values are expressed as approximations, by use of the antecedent “about,” it will be understood that the particular value forms another example. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A process comprising:
treating a lipid feedstock in a process flow through a moving bed reactor with a particulate catalyst under treating conditions to produce a treated stream, wherein:
the moving bed reactor comprises a top and a bottom,
the lipid feedstock comprises at least one fatty acid, and
the particulate catalyst comprises a metal oxide catalyst on an oxide support;
transferring the particulate catalyst from the bottom of the moving bed reactor to a fluidized bed regenerator using a catalyst withdrawal line;
regenerating the particulate catalyst using the fluidized bed regenerator;
transferring the particulate catalyst to a cyclone;
separating the particulate catalyst from flue gas using the cyclone;
transferring the particulate catalyst from the cyclone to the top of the moving bed reactor using a catalyst feed line having an inlet;
flowing a first separation gas into the inlet of the catalyst feedline to generate a first pressure differential driving the process flow through the moving bed reactor; and
flowing a second separation gas into an inlet at the bottom of the moving bed reactor or into an inlet of the catalyst withdrawal line to generate a second pressure differential further driving the process flow through the moving bed reactor.

2. The process of claim 1, wherein the cyclone is operationally located between the fluidized bed regenerator and the moving bed reactor.

3. The process of claim 1, wherein the particulate catalyst flows in a same direction as the process flow.

4. The process of claim 1, wherein the particulate catalyst flows in an opposite direction as the process flow.

5. The process of claim 1, the method comprising flowing the second separation gas into both the bottom of the moving bed reactor and into the inlet of the catalyst withdrawal line to further drive the process flow through the moving bed reactor.

6. (canceled)

7. The process of claim 1, wherein the first separation gas comprises steam or an inert gas, or wherein the second separation gas comprises steam or an inert gas.

8. (canceled)

9. The process of claim 1, wherein the particulate catalyst is transferred from the fluidized bed regenerator to the cyclone using a riser having a first end coupled to the fluidized bed regenerator and a second end coupled to the cyclone.

10. The process of claim 1, wherein the lipid feedstock is input at the top of the fluidized bed regenerator, or wherein the lipid feedstock is input between the top and the bottom of the fluidized bed regenerator.

11. (canceled)

12. The process of claim 1, wherein the moving bed reactor comprises a radial converter, and wherein the process flow includes flow of the product stream from a central axis of the radial converter to a periphery of the radial converter.

13. The process of claim 12, wherein the particulate catalyst is in a cross-flow to the flow of the product stream.

14. The process of claim 1, wherein the fluidized bed regenerator is operationally located between the cyclone and the moving bed reactor.

15. The process of claim 14, wherein the particulate catalyst flows in a same direction as the process flow within the moving bed reactor, or wherein the particulate catalyst flows in an opposite direction as the process flow within the fluidized bed regenerator.

16. (canceled)

17. The process of claim 14, wherein the catalyst withdrawal line has a first end coupled to the bottom of the moving bed reactor, and a second end, and wherein the particulate catalyst is transferred from the moving bed reactor to the cyclone using:
(i) the catalyst withdrawal line; and
(ii) a riser having a first end coupled to the second end of the catalyst withdrawal line, and a second end coupled to the cyclone.

18. The process of claim 1, further comprising withdrawing the treated stream from the bottom of the moving bed reactor, or further comprising withdrawing the treated stream from the top of the moving bed reactor.

19. (canceled)

20. The process of claim 1, wherein the treated stream comprises a renewable fuel intermediate composition.

21. (canceled)

22. (canceled)

23. The process of claim 1, wherein the metal oxide catalyst comprises at least one metal selected from the group consisting of Na, K, Mg, Ca, and Sr.

24. (canceled)

25. The process of claim 1, wherein the metal oxide catalyst comprises calcium oxide.

26. The process of claim 1, wherein the oxide support comprises alumina.

27-29. (canceled)

30. The process of claim 20, further comprising hydroprocessing a fraction of the renewable fuel intermediate composition to aviation fuel, diesel, naphtha, or gasoline.

31. The process of claim 1, wherein the treating conditions in the moving bed reactor include a temperature in a range of from 400° C. to 700° C., a pressure in a range from 0 to 10 mPa, and a liquid hourly space velocity in a range from 0.1 to 10 h⁻¹.

32. A system comprising:
a moving bed reactor to treat a lipid feedstock in a process flow through the moving bed reactor with a particulate catalyst under treating conditions to produce a treated stream, wherein:
the moving bed reactor comprises a top and a bottom,
the lipid feedstock comprises at least one fatty acid, and
the particulate catalyst comprises a metal oxide catalyst on an oxide support;
a fluidized bed regenerator to regenerate the particulate catalyst;
a catalyst withdrawal line to transfer the particulate catalyst from the bottom of the moving bed reactor to the fluidized bed regenerator;
a cyclone to separate the particulate catalyst from flue gas;
a riser to transfer the particulate catalyst to the cyclone;
a catalyst feed line to transfer the particulate catalyst from the cyclone to the top of the moving bed reactor;
the catalyst feed line having an inlet to flow a first separation gas into the catalyst feedline to generate a first pressure differential driving the process flow through the moving bed reactor; and
the bottom of the moving bed reactor having an inlet or the catalyst withdrawal line having an inlet to flow a second separation gas into the bottom of the moving bed reactor or into the catalyst withdrawal line to generate a second pressure differential further driving the process flow through the moving bed reactor.

33-62. (canceled)

63. A process comprising:
treating a lipid feedstock comprising at least one fatty acid in a moving bed reactor with a metal oxide catalyst on an oxide support under treating conditions to produce a treated stream,
wherein the moving bed reactor comprises an operable valve-free moving bed reactor loop, and
wherein the treating conditions in the moving bed reactor include a temperature in a range of from 400° C. to 700° C., a pressure in a range from 0 to 10 mPa, and a liquid hourly space velocity in a range from 0.1 to 10 h⁻¹, wherein:
(i) the moving bed reactor loop comprises reversing the process flow direction in the reactor to up-flow; or
(ii) a regenerator is present and the reactor and regenerator both flow in the same direction around the loop as the catalyst, optionally wherein the moving bed reactor loop comprises reversing the process flow direction in the regenerator to flowing in the opposite direction of the catalyst; or
(iii) the moving bed reactor loop comprises flowing the process stream in cross flow in a radial converter reactor configuration.

64-68. (canceled)
